(19) United States
(12) Patent Application Publication
(10) Pub. No.: US 2007/0296813 A1
(43) Pub. Date: Dec. 27, 2007

(54) INTELLIGENT MONITORING SYSTEM AND METHOD

(75) Inventor: MING-CHIH HSIEH, Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/615,002

(22) Filed: Dec. 22, 2006

(30) Foreign Application Priority Data
Jun. 7, 2006 (CN) 200610060981.4

(51) Int. Cl. H04N 7/18

(52) U.S. Cl. 348/143

(57) ABSTRACT

An intelligent monitor system is provided. The system includes a driver, an imaging device, a central processing unit, and a motion detection unit. The motion detection unit is used for setting a motion monitoring section in an image of a monitored area captured by the imaging device. If suspicious activity occurs in the motion monitoring section, the central processing unit controls the driver to drive the imaging device, the imaging device moves the motion monitoring section to the image center to be amplified. A related method is also provided.

### BACKGROUND OF THE INVENTION

1. Field of the Invention

The present invention relates to surveillance systems and methods, especially to an intelligent monitoring system and method.

2. Description of Related Art

Present security systems typically utilize some kind of video surveillance. The video surveillance systems may be active or passive. In a passive system, a videocassette recorder (VCR) is disposed at a remote location and is operable to record slow motion images of a certain area. The passive system, which is typically found in banks or other financial institutes, only allows security personnel to replay the videotape at a later time.

In an active system, a security person is employed to constantly observe a monitor and alert appropriate authorities (e.g. triggering an alarm) if suspicious activity is seen in the monitor.

With the development of digital technology, video cameras with pan/tilt/zoom (PTZ) functions are adopted in the active systems. A PTZ video camera is able to focus on an object at a far distance and a wide angle range and capture an amplified image of an area in the range. When suspicious activity is seen in the monitor, the security person can remotely control the PTZ camera to track and record the suspicious activity.

Compared with the passive systems, the active systems with the PTZ cameras are more efficient, however, an individual must be employed full time to observe the displays, and further, the individual must be alert.

What is needed, therefore, is an intelligent monitoring system and method, when suspicious activity occurs in a preset motion monitoring section of a surveillance area monitored by a PTZ camera, the PTZ camera can automatically move and amplify the motion monitoring section to an image center.

### SUMMARY OF THE INVENTION

An intelligent monitoring system according to a preferred embodiment is provided. The system includes a driver, an imaging device, a central processing unit, and a motion detection unit. The motion detection unit is used for setting a motion monitoring section in an image of a monitored area captured by the imaging device. If suspicious activity occurs in the motion monitoring section, the central processing unit controls the driver to drive the imaging device, the imaging device moves the motion monitoring section to the image center to be amplified.

Another embodiment provides a preferred method for intelligent monitoring. The method includes the steps of: (a) capturing an image of a monitored area by an imaging device; (b) setting a motion monitoring section in the image and an alert level of image deviation in the motion monitoring section; (c) setting a two-dimensional grid for the image and dividing the image equally corresponding to the x-axis, y-axis of the two-dimensional grid; (d) computing coordinate values of the image center and the motion monitoring section center in the two-dimensional grid; (e) computing a distance between the image center and the motion monitoring section center; (f) detecting whether image deviation of the motion monitoring section exceeds the alert level; (g) moving the motion monitoring section to the image center, if the image deviation in the motion monitoring section exceeds the alert level; and (h) amplifying the motion monitoring section.

Other objects, advantages and novel features of the present invention will be drawn from the following detailed description of the preferred embodiment and preferred method of the present invention with the attached drawings.

### BRIEF DESCRIPTION OF THE DRAWINGS

FIG. 1 a schematic diagram of application environment of an intelligent monitoring system according to a preferred embodiment;

FIG. 2 is a block diagram illustrating the system in FIG. 1;

FIG. 3 is a schematic diagram illustrating main function modules of a motion detection unit in FIG. 2;

FIG. 4 is a flowchart of a preferred method for intelligent monitoring; and

FIG. 5 to FIG. 7 show an example of a process of monitoring a designated region.

### DETAILED DESCRIPTION OF THE PREFERRED EMBODIMENT

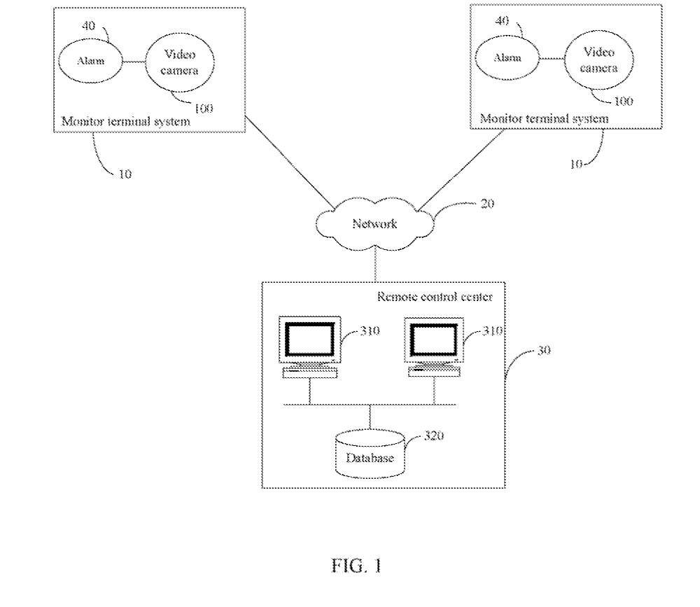

FIG. 1 is an illustration of application environment of a system incorporating the present invention in accordance with a preferred embodiment. The system typically includes at least one monitor terminal system 10 (two shown in FIG. 1), a network 20, and a remote control center 30. The at least one monitor terminal system 10 connects to the remote control center 30 via the network 20.

Each monitor terminal system 10 includes a video camera 100 and an alarm 40. The video camera 100 captures consecutive images of a monitored area. When any suspicious activity occurs in a predetermined motion monitoring section of the monitored area, the video camera 100 focuses a center of the video camera 100 to the motion monitoring section, zooms in the motion monitoring section, and sounds the alarm 40.

The remote control center 30, which includes a plurality of computers 310 and a database 320, can access and control the monitor terminal system 10 through the network 20. Each computer 310 synchronously displays consecutive images captured by the video camera 100 on a display coupled to the computer 310 (not shown). Furthermore, the computer 310 may send commands to the video camera 100 of the monitor terminal system 10 via the network 20, so as to control a movement of the video camera 100. The database 320 is used for storing the consecutive images captured by the video camera 100.

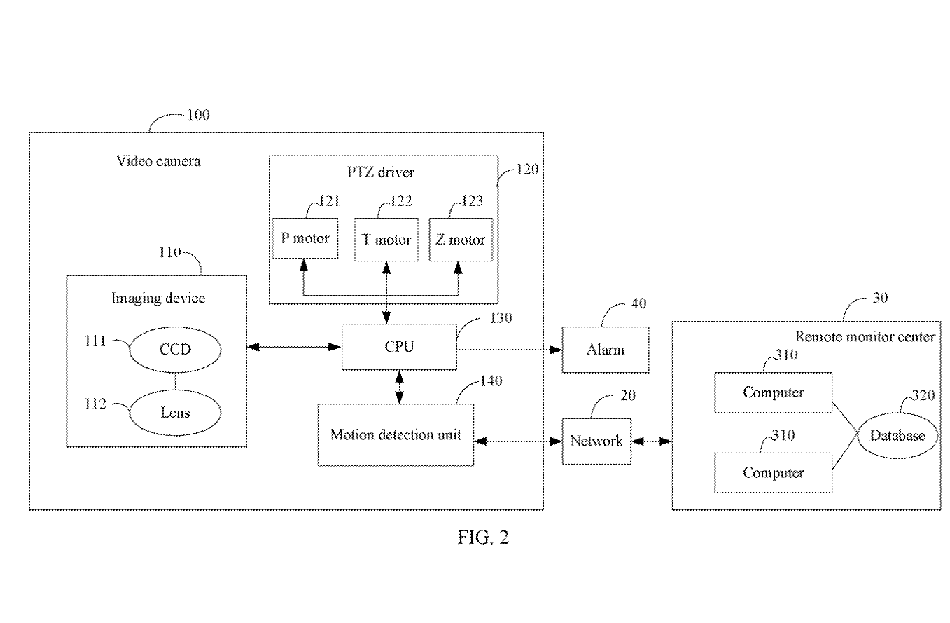

FIG. 2 is a block diagram illustrating the intelligent monitoring system according to a preferred embodiment. The video camera 100 mainly includes an imaging device 110, a PTZ driver 120, a central processing unit (CPU) 130, and a motion detection unit 140. The imaging device 110 includes a charged coupled device (CCD) 111 and a lens 112. The PTZ driver 120 includes a pan (P) motor 121, a tilt (T) motor 122, and a zoom (Z) motor 123 for driving x-axis movement, y-axis movement of the lens 112, and adjusting a foci of the lens 112 respectively. The CCD 111 captures images of the monitored area via the lens 112. The motion detection unit 140 sets at least one motion monitoring section in the monitored area. When any suspicious activity occurs in the motion monitoring section, the CPU 130 triggers the alarm 40, and controls the PTZ driver 120 to drive the lens 112 to move the motion monitoring section to the center of the image captured by the lens 112 and amplify the motion monitoring section. In this embodiment, the CPU 130 is configured internally within the video camera 100. In other embodiments, the CPU 130 may also be configured externally of the video camera 100, such as in an application server connected to the video camera 100.

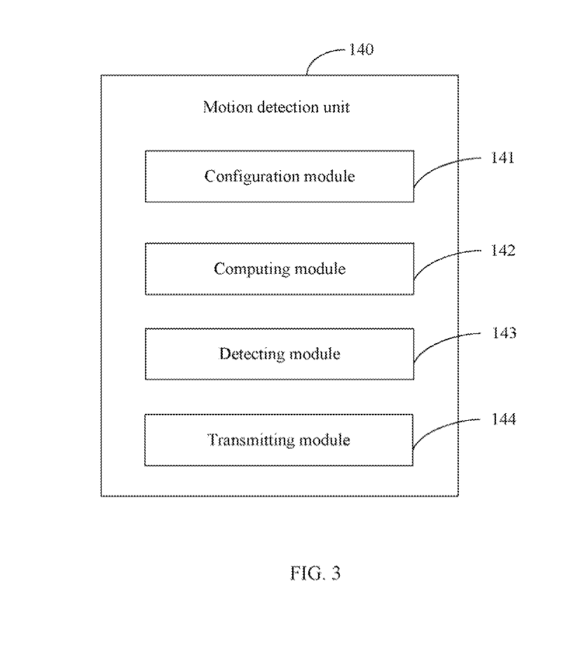

FIG. 3 is a schematic diagram illustrating main function modules of the motion detection unit 140 in FIG. 2. The motion detection unit 140 includes a configuration module 141, a computing module 142, a determining module 143, and a transmitting module 144.

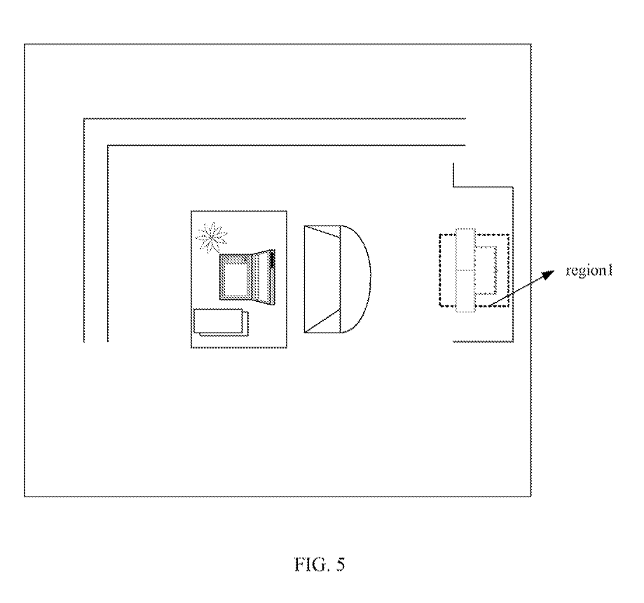

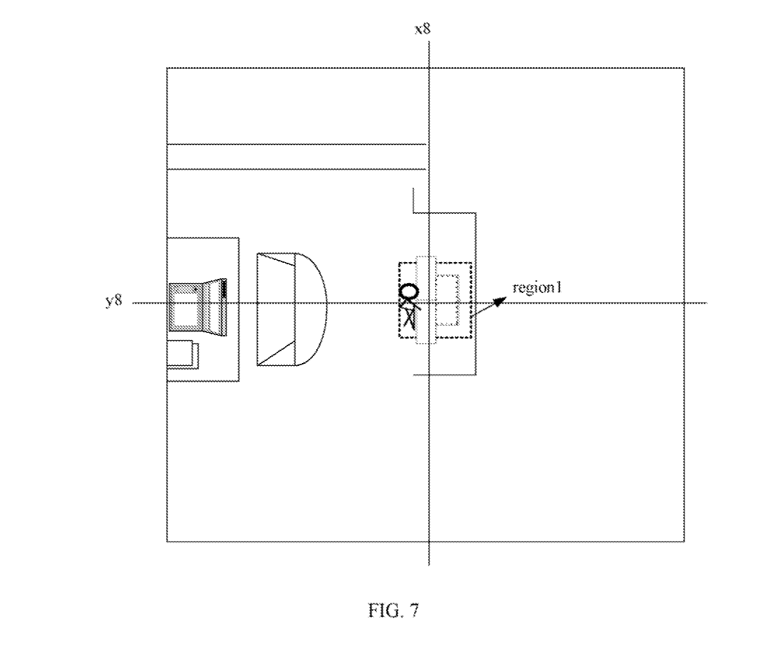

The configuration module 141 is used for setting at least one motion monitoring section in the monitored area (such as a region 1 shown in FIG. 5), setting a two-dimensional grid on the consecutive image of the monitored area captured by the video camera 100, and setting an alert level for an image deviation (e.g. 70%) in the motion monitoring section (e.g. region 1) of the captured image compared with a previous captured image of the consecutive captured images. In this embodiment, the image deviation is computed as follows: dividing the motion monitoring section into predetermined equal divisions (e.g. 20 equal divisions), if no deviations occurs in the motion monitoring section (that is, the captured image and the previous captured image are the same), the image deviation is: 0/20=0%; if deviation occurs in two equal divisions of the 20 equal divisions, the image deviation is: 2/20=10%. The more the motion monitoring section is divided, the higher the precision of monitoring is. The alert level is a threshold value for triggering the alarm 40. For example, when the image deviation of region 1 shown in FIG. 5 exceeds 70%, the CPU 130 triggers the alarm 40, and the region 1 is moved to the center of the image shown in FIG. 7.

The computing module 142 is used for computing coordinate values of the image center and the motion monitoring section center, and computing a distance between the image center and the motion monitoring section center, in the two-dimensional grid.

The detecting module 143 is used for detecting whether suspicious activity occurs in the motion monitoring section by detecting whether the image deviation exceeds the alert level.

The transmitting module 144 is used for transmitting the image captured by the video camera 100 to the computer 310 in the remote control center via the network 20.

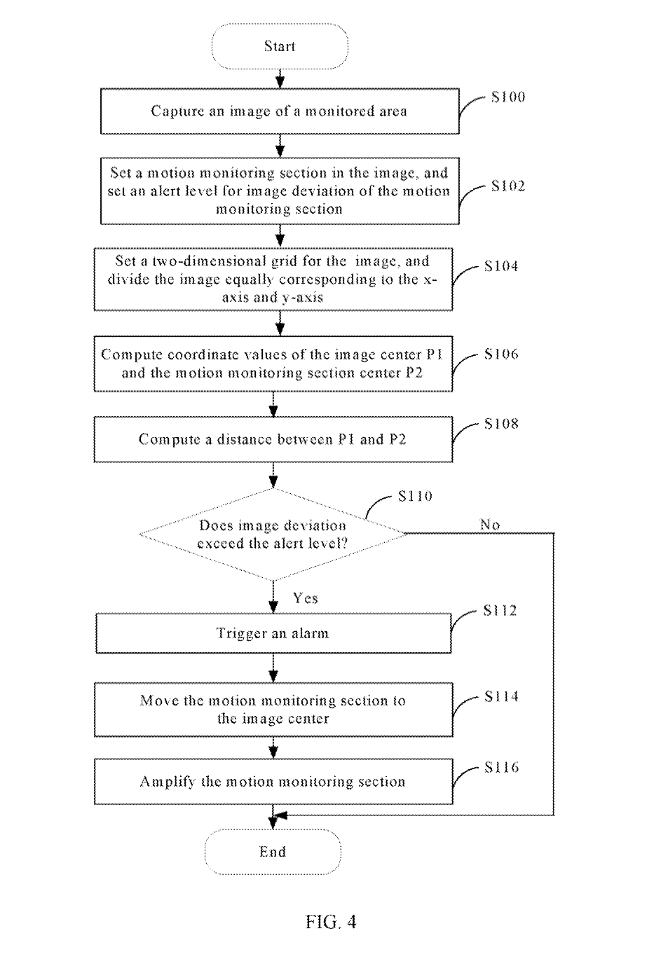

FIG. 4 is a flow chart of a preferred method for intelligent monitoring. In step S100, the imaging device 110 captures the image of a monitored area. In step S102, the configuration module 141 sets a motion monitoring section in the image, and sets an alert level for image deviation in the motion monitoring section. In step S104, the configuration module 141 sets a two-dimensional grid for the image, and divides the image equally corresponding to the x-axis and y-axis of the two-dimensional grid. In step S106, the computing module 142 computes coordinate values of the image center and the motion monitoring section center by utilizing mathematics theory, such as the least square method. In step S108, the computing module 142 computers a distance between the image center and the motion monitoring section center. In step S110, the detecting module 143 detects whether the image deviation of the motion monitoring section exceeds the alert level. If the image deviation does not exceed the alert level, the procedure ends. Otherwise, if the image deviation exceeds the alert level, in step S112, the CPU 130 triggers the alarm 40. In step S114, the CPU 130 controls the PTZ driver 120 to drive the imaging device 110 to move the motion monitoring section to the center of the image, according to the distance between the image center and the motion monitoring section center. In step S116, the PTZ driver 120 drives the imaging device 110 to amplify the motion monitoring section, and the procedure ends.

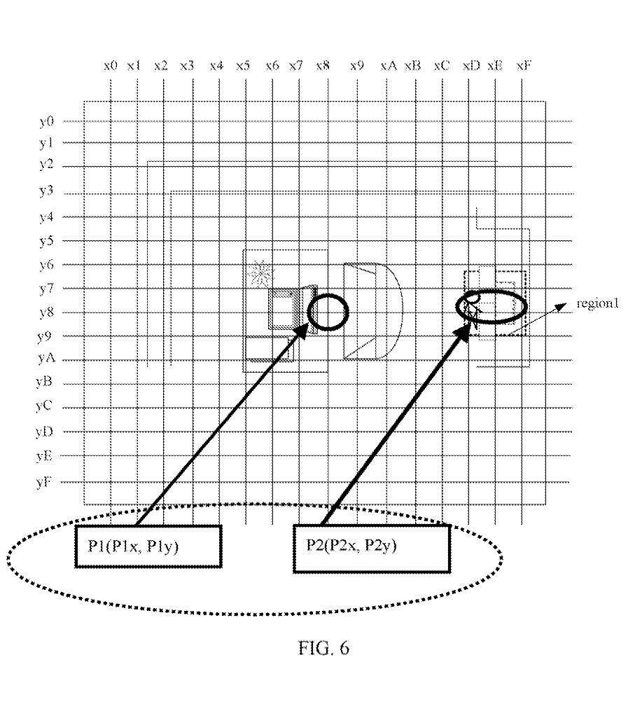

FIG. 5 to FIG. 7 show an example of a process of monitoring a designated region. FIG. 5 gives an image of a monitored area captured by the video camera 100, in which the configuration module 141 sets a motion monitoring section “region 1” in the image, and sets an alert level as 70%. As shown in FIG. 6, the configuration module 141 sets a two-dimensional grid for the image, and parts the image corresponding to the X-axis, Y-axis to “x0˜xF”, y0˜yF. The computing module 142 computes coordinate values of the image center P1 (P1x, P1y), and computes coordinate values of the region 1 center P2 (P2x, P2y) by utilizing the least square method. Then, the computing module 142 computes a distance between P1 and P2: x0=P2x−P1x, y0=P2y−P1y. Supposing that: x0=5.5 grids, y0=1 grids, the P motor 121 and T motor 122 are both stepper motors, and one step of clockwise rotation drives the lens 112 to move 0.5 grid along the forward direction of the x-axis or y-axis. As a result, if the image deviation of region 1 exceeds 70%, the CPU 130 controls the P motor 121, T motor 122 clockwise rotates 11 steps and 2 steps respectively to move the region 1 to the image center as shown in FIG. 7. At last, the CPU 130 controls the Z motor 123 to adjust a foci of the lens 112 to amplify the region 1 shown in FIG. 7.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. An intelligent monitoring system comprising a driver, an imaging device, a central processing unit, and a motion detection unit, the motion detection unit being for setting a motion monitoring section in an image of a monitored area captured by the imaging device, the central processing unit controlling the driver to drive the imaging device to move the motion monitoring section to the image center and amplify the motion monitoring section, when any suspicious activity occurs in the motion monitoring section.

2. The system as claimed in claim 1, wherein the motion detection unit comprises:
a configuration module for setting the motion monitoring section in the image captured by the imaging device, setting a two-dimensional grid for the image, and setting an alert level for image deviation in the motion monitoring section; and
a computing module for computing image deviation of the motion monitoring section, computing coordinate values of the image center and the motion monitoring section center, and computing a distance between the image center and the motion monitoring section center.

3. The system as claimed in claim 2, wherein the motion detection unit further comprises a detecting module for detecting whether the suspicious activity occurs in the motion monitoring section by determining whether the image deviation in the motion monitoring section exceeds the alert level.

4. The system as claimed in claim 2, wherein the motion detection unit further comprises a transmitting module for transmitting the image captured by the imaging device to a remote control center via a network.

5. The system as claimed in claim 2, wherein the driver is for driving the imaging device to move the motion monitoring section according to the computed distance.

6. An intelligent monitoring method, comprising the steps of
capturing an image of a monitored area by an imaging device;
setting a motion monitoring section in the image and an alert level for image deviation in the motion monitoring section;
setting a two-dimensional grid for the image and dividing the image equally corresponding to the x-axis, y-axis of the two-dimensional grid;
computing coordinate values of the image center and the motion monitoring section center in the two-dimensional grid;
computing a distance between the image center and the motion monitoring section center;
detecting whether image deviation of the motion monitoring section exceeds the alert level;
moving the motion monitoring section to the center of the image, if the image deviation in the motion monitoring section exceeds the alert level; and
amplifying the motion monitoring section.

7. The method as claimed in claim 6, further comprising the step of
transmitting the image captured by the imaging device to a remote control center through a network.
